(19) United States
(12) Patent Application Publication
(10) Pub. No.: US 2005/0267799 A1
(43) Pub. Date: Dec. 1, 2005

(54) System and method for enabling publishers to select preferred types of electronic documents

(76) Inventors: Wesley Chan, Mountain View, CA (US); Gokul Rajaram, Mountain View, CA (US); Deepak Jindal, Sunnyvale, CA (US); Rama Ranganath, Mountain View, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/841,828

(22) Filed: May 10, 2004

(51) Int. Cl. G06F 17/60; G06F 15/16; G06F 15/00; G06F 17/00; G06F 17/21; G06F 17/24

(52) U.S. Cl. 705/14; 715/513

(57) ABSTRACT

A system and method for providing preferred types of electronic documents. The system enabling a provider of electronic documents to select at least one preference regarding one or more types of electronic document to be received and published from an advertisement distribution system, receiving a request for at least one electronic document from the provider, the request including one or more content-based criteria, selecting one or more electronic documents based on the at least one preference and the one or more content-based criteria, and enabling the provider to publish the preferred types of electronic documents.

### FIELD OF THE INVENTION

The present invention relates to a system and method for enabling publishers to select preferred types of electronic documents.

### BACKGROUND OF THE INVENTION

Internet content providers often provide electronic documents or portions thereof to publishers, which then publish the document or portions thereof through various forums. For example, a distributor of advertisements may maintain a system that enables advertisers to store their advertisements, and enables publishers to receive and publish such advertisements on various Internet websites.

These publishers often publish many electronic documents in various locations. For example, various pages associated with URLs hosted and managed by a single entity publisher may publish different advertisements on the various pages it controls.

Publishers of various electronic documents on the Internet often require that electronic documents they publish be of a certain file type. For example, an Internet web site that sells space for advertisements on its pages and other sites may require that all advertisements contain text only. Further, the internet content provider that sells space for advertisements on its pages and/or those of others may control the font, color and size of the text advertisements. If the characteristics or type of advertisement published changes, the internet content provider must enable those changes on its own Internet web site, and also enable the changes at all other places where the advertisement is published.

These and other drawbacks exist with current systems and methods.

### SUMMARY OF THE INVENTION

Accordingly, various embodiments of the present inventions may be directed to a system and a method for publishing preferred types of electronic documents, involving enabling a provider of electronic documents to select at least one preference regarding one or more types of electronic documents to be received and published from an advertisement distribution system, receiving a request for at least one electronic document from the provider, the request including one or more content-based criteria, selecting one or more electronic documents based on the at least one preference and the one or more content-based criteria, and enabling the provider to publish the preferred types of electronic documents.

Other embodiments are also within the scope of the invention.

### BRIEF DESCRIPTION OF THE DRAWINGS

FIG. 1 depicts a system for publishing preferred types of electronic documents according to an embodiment of the invention.

FIG. 2 depicts a networked environment for operation of a system for selecting types of electronic documents and publishing those types according to an embodiment of the invention.

FIG. 3 depicts a flow chart illustrating an exemplary method for publishing preferred types of electronic documents according to an embodiment of the invention.

FIG. 4 depicts an exemplary electronic document according to an embodiment of the invention.

FIG. 5 depicts an exemplary electronic document type selection according to an embodiment of the invention.

### DETAILED DESCRIPTION OF EXEMPLARY EMBODIMENTS

The embodiments described herein solve many problems with existing systems and methods. Various embodiments are provided that enable recipients/publishers of electronic documents, such as advertisements, to select what types of such electronic documents that it desires to receive from an electronic document source, such as an advertisement distribution system. In one specific embodiment, an advertisement distribution system that receives various types of electronic documents, including text-based advertisements, graphical advertisements, flash-type graphical advertisements and audio-based advertisements, for example, stores preferences for recipient/publishers on a global or page-by-page (e.g., designated by URL) basis. The advertisement distribution system may then deliver the types of advertisements desired by the recipient/publisher without the publisher having to change any source code that it uses to publish the received documents.

Providing a mechanism by which a publisher may control the type of electronic documents received for publication in locations controlled by the publisher minimizes the burden on both publisher and content provider when additional types of electronic documents or advertisements are developed. Moreover, each publisher may have unique preferences regarding the type of electronic documents published on its sight. A publisher may prefer that all electronic documents published on its site be the same type, in order to create an even playing field. Alternatively, a publisher may desire to publish as many diverse types of electronic documents as advertisers seek to publish.

Embodiments described herein overcome problems associated with modifying the types of electronic documents provided in an effective manner, while making modifications optional for a publisher and other problems by allowing a publisher to select types of electronic documents it will publish globally or on a more limited basis. Each publisher may select to publish all types of electronic documents on all URLs it controls. Or, the publisher may select only certain types of electronic documents to be made available to selected pages (identified by associated URL's), certain types of electronic documents on all URLs it controls or any combination thereof.

While the term “advertisement” may be used as an illustrative example, it should be appreciated that the same system and method may be applied to other forms of documents or electronic documents. As used herein, the term “document” and “electronic document” may encompass one or more advertisements, content pages (e.g., web pages), search results, emails, applications, IM messages, audio content or files, video content or files, other files, other data or applications that may reside on one or several (e.g., a network) of computer systems, or other definable concepts or content.

Overview and System Illustration

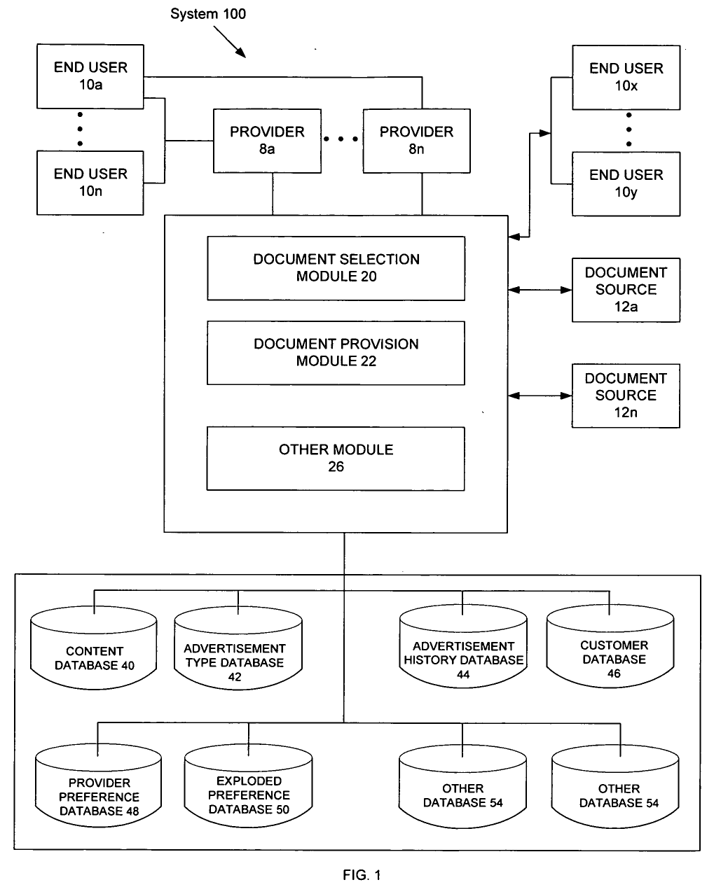

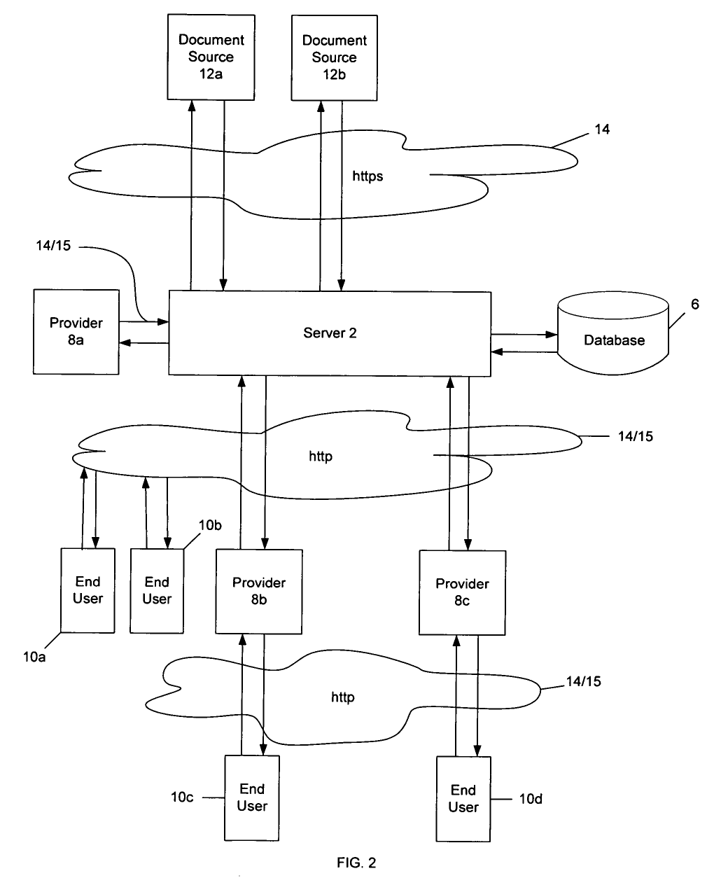

According to one exemplary embodiment, as shown in FIGS. 1 and 2, for example, one or more document sources 12 provide one or more documents to a server 2. Although a single server 2 is depicted, it should be appreciated that multiple servers 2 may be provided and that such multiple servers may share data and operational tasks to best achieve efficiency and operation of the functions described herein. Server 2 may pass one or more documents and may make the document available to the one or more provider 8 for publication. Providers 8 may make one or more electronic documents, such as advertisements, available to one or more end users 10.

One or more documents may be requested from server 2. For instance, a provider 8 and/or end user 10 may request the document. The request may come in the form of a signal that the server interprets as a request for the document, even though the signal does not specifically indicate that a document is being requested. For example, an end user may transmit a signal to a server that requests a web page, and that signal may be interpreted as a request for an advertisement document as well. The server 2 may determine whether any documents are available to respond to the signal based on one or more potential documents' rating and/or one or more criteria (e.g., whether the document meets or is related to content associated with the signal). Server 2 may pass one or more documents to a recipient, such as the requesting entity. The server 2 may identify other criteria associated with the signal (and/or the recipient of the document, if different from the requestor). While the criteria may be based on the content of the signal or request for a document (e.g., a search request for a keyword or the like), the criteria may also be based on preferences associated with the recipient. For instance, the server 2 may identify document type preferences associated with the requestor or recipient. If the requestor is identified with a preference not to deliver text-only advertisements, the server 2 may determine whether any available documents are a different type than text-only.

FIG. 1 depicts a system 100 for providing certain types of electronic documents, as directed by one or more provider 8. The system comprises a server 2, one or more providers 8, one or more document sources 12, one or more end users 10, and one or more databases 6 operatively connected to server 2.

System 100 includes one or more servers 2 that perform a number of functions, including requesting, receiving and/or processing types of electronic documents. Document sources 12, providers 8, and end users 10 may communicate with one or more servers 2 via electronic communication, including Internet communications. Document sources 12, providers 8, and end users 10 may include or have access to one or more servers 2 for providing functionality associated with electronic documents.

Information that may be communicated between and among server 2, providers 8, document sources 12, and end users 10 may include one or more of the following: document information, document type, provider preferences, source code and/or evaluator or provider information. The document information may include one or more of the following: the document itself, any language(s) used in the document, length information, file type information (e.g., html, doc, zip, etc.), type of document (text only, image, flash, audio, etc.), summary information, audio-visual content (e.g., pictures of faces, song lyrics, etc.), the identity of the document owner and/or the document creator, information about the document's intended audience (such as geographic area, age range, gender, race, national origin, religion, other demographic information), and any other information related to a document or to the server 2, providers 8, or document sources 12.

Document sources 12 may provide documents to server 2 or server 2 may “pull” or retrieve documents from document sources 12. For instance, the document source 12 may provide an advertisement to server 2 so that the server 2 may then provide the advertisement to one or more content providers 8 that may provide the ad to one or more end users 10 (or server 2 may provide the ad directly to the end user 10). Document sources 12 may include any content creator or content provider 8, such as an advertisement listings provider or server.

Providers 8 may provide documents to one or more end-users, 10a through 10n. Providers 8 may include a content provider, search engine or other entity that makes available information, services, and/or products over an electronic network, such as the Internet. A provider 8 may include one or more of the following, for example: an advertisement listings provider, an electronic document provider, a website host, a server, any other entity that provides electronic documents to users or other entities, or any other provider of content. A provider 8 may be a document source 12.

An end user 10 may be one or more persons, computers, computer networks, or other entity on a network. An end user 10 may request and receive content from a provider 8 and/or server 2. Additional participants may be included based on various applications.

The server 2 may comprise any server, hub, central processor, provider, search engine, or other entity in a network. A database 6 coupled to the server 2 may include one or more databases 40-54. Also, databases 40-54 may comprise portions of a single database 6. It should be appreciated that the databases 40-54 may or may not be physically distinct. The server 2 and its modules 20-36 may store and access information stored in the database(s) 6, 40-54.

A content database 40 may store documents. The documents may be categorized by type, or uncategorized. The documents may be received from document sources 12 and providers 8, or they may be otherwise stored by the server 2. The content database 40 may identify documents of a certain type and/or group or otherwise associate documents together. For instance, documents may be identified and/or associated with other documents according to one or more of the following features: subject matter, advertisement type, content type, language, geographic origin (e.g., country or city of origin), geographic area of target audience, document source 12, owner of content, creator of content, target demographic, or other criteria.

An advertisement type database 42 may store the type of electronic document received from document source 12 or alternatively, the server may determine the type of electronic document provided.

An advertisement history database 44 may store historical information associated with a particular advertisement, or alternatively historical information associated with a particular type of advertisement. For instance, the advertisement history database 42 may store information relating to number of clicks on a document, verification information (such as a content creator vouching for the appropriateness of a particular document), and comparisons to similar advertisements of different types. Normalization and other statistical and/or data processing techniques can be used to process the data, as will occur to those skilled in the art.

A customer database 46 stores information about providers 8 and end users 10 who may request documents. For instance, the customer database 46 may identify the gender, age, name, country of origin, and other personal information about an end user 10 or other content requestor.

A provider preference database 48 stores information on the types of electronic documents each provider 8 prefers and publishes to end users 10; or the types of electronic documents each provider 8 will not publish.

An exploded preference database 50 stores information on the types of electronic documents selected and allowed for publication on each URL controlled by providers 8.

Other database(s) 54 may store other information relating to the providers 8, end users 10, document sources 12, server 2, advertisement type 42, advertisement history 44, customer database 46, provider preference database 48, and exploded preference database 50.

The server 2 may comprise one or more modules to process content, preferences, and other data.

A document selection module 20 may select documents to be published. The module may select the documents stored in the content database 40. The document selection module may select documents only of types preferred by a certain provider 8. Documents may also be selected according to subject matter, financial data, performance data, geographic origin, identity of owner, identity of creator, and/or other information associated with the document.

A document provision module 22 may select and provide documents in response to a request from a provider 8, end user 10, or other entity. For instance, a dvd retailer may request an advertisement to display on their site. In response, the document provision module 22 may identify or determine document type preferences associated with the dvd retailer and then select a document based on this information. For instance, if the dvd retailer prefers flash advertisements only, the document provision module will select an advertisement for delivery based upon this information.

Other module(s) 26 may accomplish other functions related to rating electronic documents.

Illustrative System Network Environment

FIG. 2 depicts a networked environment for operation of a system for providing preferred types of documents according to an embodiment of the invention. In such an environment, providers 8 may connect over a network 14 (e.g., http), 15 (e.g., https) to a server 2 (e.g., using a secure https connection) to provide documents and preference information to server 2 and to receive documents and information from server 2. The server 2 may store the document and preference information in one or more database(s) 6. The server 2 may distribute the documents through various forums or feeds, including direct distribution in print media, providing the documents on one or more web sites affiliated with the server 2 and/or through providers 8. It should be noted that providers may comprise syndication partners of the server 2 (e.g., connected over network 14 or 15 depending on security desired), content systems (e.g., with associated content databases) and search engine systems operated by the server 2 or provider(s) 8.

Through these various forums, the documents provided to the providers 8 may be included in pages (or other documents) displayed to end-users 10 (often called an impression).

Each of server 2, providers 8, and document sources 12 may comprise computerized systems that include one or more of the following systems: a web server, a database server, proxy server, network balancing mechanisms and systems, and various software components that enable the system to operate on the internet or other network type system. Additionally, networks 14 and 15, although depicted as http/https networks, may comprise other networks such as private lines, intranets, or any other network. In an exemplary embodiment, the connection between a document source 12 such as an advertisement provider and server 2 (and other connections such as between a provider 8 and server 2) may comprise secure network connections to insure that data is not subject to attack or corruption by any hacker or other third party. In addition, whereas two document providers 12 are depicted, it should be appreciated that one or more document providers 12 may be provided in the network. Similarly, although one database 6 is depicted, it should be appreciated that multiple databases 6 may be provided and that such databases 6 may be connected to the server 2 via any type of network connection, including a distributed database server architecture.

Similarly, provider 8a may comprise any number of such systems connected to the server 2 via any type of network, including an http or https network. Content provider 8 may comprise a system such as server 2 that provides functionality for enabling connection over the internet or other network protocols. End users 10 may comprise any user (such as users connected to the internet) and may comprise computerized systems that enable that connection through any of various types of networks, including through internet service providers, cable companies, and any other method of accessing data on the internet. Providers 8 may comprise any system that distributes content such as advertising to end-users 10.

Illustrative Process

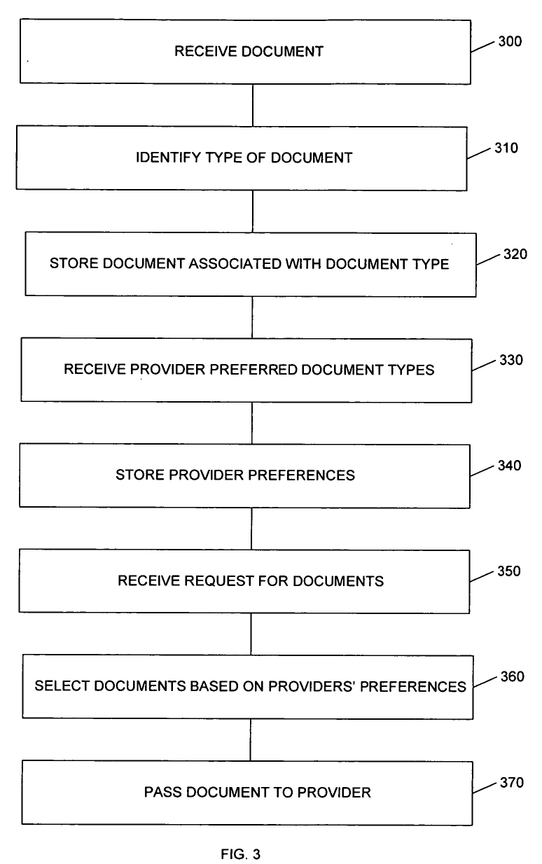

FIG. 3 is a flow chart illustrating an exemplary method for providing preferred types of electronic documents according to an embodiment of the invention. The method described herein may be implemented by the systems described in FIGS. 1 and 2.

In block 300, one or more documents may be received. For instance, the server may receive one or more advertisements from one or more partner advertisers or other content providers. Alternately or in addition, the server may generate one or more documents.

In block 310, the server may identify the type of document received. For instance, the server may identify the type of document via metadata associated with the file, through the document's source, or through the file extension.

In block 320, the identified document and the document type may be stored in an associative database. The document type may be stored using numerical values, codes, text or other values.

In block 330, the providers may input their preferences for types of documents. For instance, a provider may prefer to provide text-only ads, and nothing else. Also, a provider may prefer flash advertisements first, then image advertisements, and lastly, text-only advertisements. Optionally, the server may determine whether additional software or source code may assist the provider in operating the preferred type of advertisement. If so, the server may provide it to the provider.

In block 340, the provider's preferences may be stored in a database. This may or may not be the same database where the identified document is stored. The provider may be associated with a provider code, URL, or other designator sufficient to identify the provider when a request for electronic documents is received from the provider.

In block 350, a request for a document may be received. For instance, the server may receive a request for a document from a provider 8 or an end user 10. The request may include information sufficient to identify the provider such that server 2 may identify the preferences to be applied. As discussed below, the provider may also include preference information in the request and/or preference override information. Moreover, because this system and method may operate in connection with a content-based targeted advertising system, the request may also include, reference or otherwise indicate content for which the electronic document is being requested. For example, in the context of a content-based targeted advertisement system, the request may indicate a request for advertisements related to basketball.

In block 360, a document may be selected. For instance, a server that receives a request for a document from a user or provider may select a document for the user or provider. The selecting may be based on provider's stored preferences and the stored identified document types. In addition, as discussed above, in the context of a targeted content-based document system, the documents may be selected based on the content indicated from the request. Using the example in block 350 above, the provider supplying the request may have preferences indicating that graphical advertisements are acceptable and the request may indicate that the content sought is basketball-related. In that case, the database may be checked for basketball-related graphical advertisements. If more than a predetermined number are available, then the determination as to which advertisements to provide may be based on various parameters, including price-based parameters and performance-based parameters. Various example systems and methods used for determining advertisements and other electronic documents are described in co-pending U.S. patent application Ser. No. 10/375,900, filed Feb. 26, 2003, entitled “Serving advertisements based on content,” the subject matter of which is hereby incorporated by reference in its entirety. Also, other example systems and methods for delivering graphical advertisements are described in co-pending U.S. patent application Ser. No. 10/742,791 entitled “Method and system for providing targeted graphical advertisements,” the subject matter of which is also incorporated by reference in its entirety.

In block 370, one or more selected documents may be passed to the requesting entity. For instance, if a provider or user requested a document in block 350, the server may pass the selected document to the provider or user, as the case may be. Also, the documents may be made available for download. Other techniques for enabling the document to be utilized by the provider or by the server itself may also be utilized.

It will be appreciated to those skilled in the art that the acts described may be performed by hardware, software, or a combination thereof, with or without human intervention, as may be embodied in one or more computing systems such as a server system coupled to entities such as providers, evaluators, and end users. Also, it is not necessary that the action(s) of each block be performed in the order shown in FIG. 3. Any orderings may be considered.

It should be noted that the provider's preferences may be determined after a user or content provider requests a document from the server rather than before such request. Because the provider's preferences may change over time, obtaining up-to-date preferences for a document before providing it to a user or provider may maximize the likelihood that the document is in the provider's preferred format.

Illustrative User Interface and Results

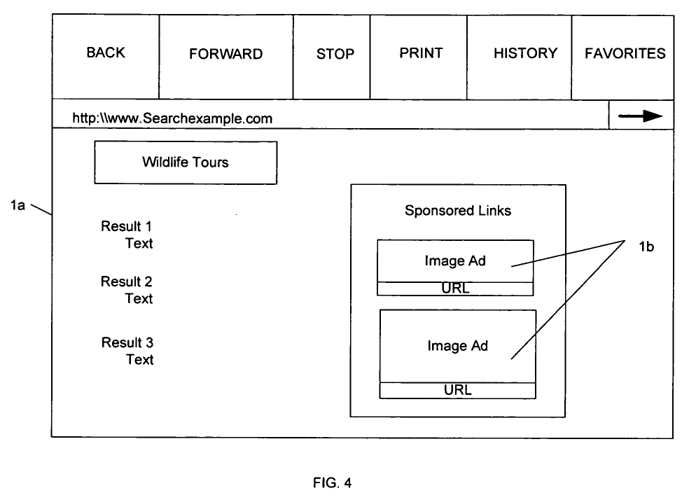

FIG. 4 shows an exemplary document 1 according to an embodiment of the invention. FIG. 4 depicts an exemplary web page 1a search result from an internet search engine. The web page 1a itself may be a document. Content on the web page 1a may also be a document. For instance, the advertisements 1b on the search result page 1a may also be documents. Other types of documents may be considered, such as advertisements, files, programs, and other information.

The document may have various types of content. For instance, the document may have words, images, sounds, and other information, as well as functions or programs which may produce words, images, sounds, and other information.

For instance, the document may have a picture of a bikini-clad woman holding a glass of wine and an associated title stating “Fun in the sun with WineCo brand wine.” Another document may show a man holding a gun pointed at an icon that says “debt.” Another document may state “investments with FundCo yielded 6.25% over prime last year.” Another document may show children dancing underneath a rainbow and singing “It's a Small World After All.” Another document may have an icon which, when clicked, allows the user to virtually duck hunt by using a cursor to aim a rifle at ducks sitting in a lake, as in a video game.

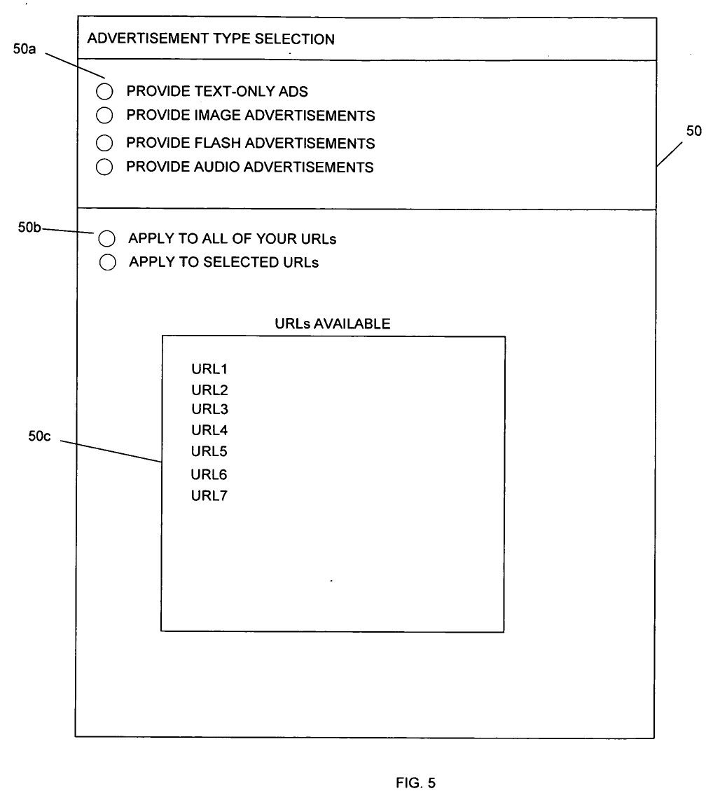

FIG. 5 shows an exemplary advertisement type selection interface 50 according to an embodiment of the invention. The provider may select the types of advertisement the provider prefers at 50a. Additionally, the providers may select whether the provider wants to apply these preferences to all URLs the provider manages, or to selected URLs at 50b. If the provider chooses to apply preferences to only selected URLs, the provider may choose precisely which URLs at 50c. Additional iterations of using advertisement type selection interface 50 may be presented until the provider has customized preferences for each URL, if separate selections for various URL's are desired. If the provider requests an advertisement type that has not previously been enabled on that URL, the server may provide source code to enable the provider's preference.

In addition, in certain circumstances (e.g., specific pages or during specific time periods), the provider may elect to override preferences stored on server 2. The provider may then utilize advertisement type selection interface 50 to change preferences for the page, pages, or globally for all pages. Also, for a variety of reasons (e.g., the change is going to be brief, the change only affects one advertisement location on a page and not others, convenience, etc.), the provider may desire a mechanism to override preferences set at server 2. To achieve this result, the requesting call to server 2 may be modified to include one or more codes that identify the override preference desired. For example, if Provider A has four URL's www.providerA.com/Page1/, www.providerA.com/Page2/, www.providerA.com/Page3/, and www.providerA.com/Page4/and has elected to receive all types of advertisements on the first three of those URL's, but only text-based advertisements on the fourth (www.providerA.com/Page4/), the pages provider to end users at those URL's will include HTML, XML, JAVA or other codes to request one or more advertisements from server 2 using known techniques for advertisement inclusion.

If an override is desired, the code transmitted to request the one or more advertisements may be modified to include manual override codes to instruct server 2 to apply a difference preference for the single request, until a certain time period, for a given session, etc. While the codes used may vary and many such codes would be within the skill of one of ordinary skill in the art, examples include the following using two variables (one for minimum image advertisements and the second for maximum image advertisements):
min_img_ads—minimum image advertisements and max_img_ads—maximum image advertisements.

If the publisher wants text ads or one image advertisements, the variables may be set to min_img_ads=0 and max_img_ads=1.

If the publisher wants no text ads and only one image advertisement, the variables may be set to min_img_ads=1 and max_img_ads=1.

If the publisher wants no text ads and multiple image advertisements (if available), the variables may be set to min_img_ads=1 and max_img_ads=N.

If the publisher wants M text ads or N image advertisements, the variables may be set to min_img_ads=0; max_img_ads=M; and num_rhs_ads_to_show=N.

Other variables, parameters, and values may be used within the scope of the present invention to achieve override of preferences. For example, when more than two types of advertisements are available, additional parameters and values may be used.

The embodiments of the present inventions are not to be limited in scope by the specific embodiments described herein. For example, although many of the embodiments disclosed herein have been described with reference to advertisements, the principles herein are equally applicable to documents and other content. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A method comprising:
enabling a provider of electronic documents to select at least one preference regarding one or more types of electronic document to be received and published from an advertisement distribution system;
receiving a request for at least one electronic document from the provider, the request being associated with one or more content-based criteria; and
selecting one or more electronic documents for publication by the provider based on the at least one preference and the one or more content-based criteria.

2. The method of claim 1, further comprising:
enabling the provider to publish types of electronic documents consistent with the provider's preference.

3. The method of claim 1, further comprising:
delivering at least one selected document to the provider.

4. The method of claim 1, wherein one preferred type of electronic document is an image advertisement.

5. The method of claim 1, wherein one preferred type of electronic document is an audio file.

6. The method of claim 1, wherein one preferred type of electronic document is a flash file.

7. The method of claim 1, further comprising:
receiving one or more override codes with the request, overriding preferences and using that code to determine the electronic documents to select.

8. The method of claim 7, wherein the override code changes electronic document types preferred for that request.

9. The method of claim 7, wherein the override code indicates additional preferences for that request.

10. The method of claim 1 wherein an electronic document comprises an Internet advertisement.

11. The method of claim 1, further comprising:
receiving advertisements from advertisers and associating them with content subjects for selection based on content requests.

12. The method of claim 1 further comprising:
enabling an advertiser to provide a plurality of types of advertisements and indicate which should be made available for publication by providers.

13. A computer-readable medium encoded with computer program code to provide preferred types of electronic documents to providers, the program code effective to perform the following:
enabling a provider of electronic documents to select at least one preference regarding one or more types of electronic document to be received and published from an advertisement distribution system;
receiving a request for at least one electronic document from the provider, the request including one or more content-based criteria;
selecting one or more electronic documents based on the at least one preference and the one or more content-based criteria; and
enabling the provider to publish the preferred types of electronic documents.

14. A system comprising:
preference receiving means for receiving from a provider of electronic documents at least one preference regarding one or more types of electronic documents for the provider to receive and publish;
request receiving means for receiving a request for at least one electronic document from the provider, the request including one or more content-based criteria; and
delivery means for delivering at least one electronic document to the provider based on the at least one preference and the one or more content-based criteria.

15. A system comprising:
receiving means for receiving provider's one or more preferences for types of electronic documents;
storage means for storing the provider's one or more preferences.
selection input means for selecting electronic documents for delivery to the provider based upon the provider's preferences and one or more content-based criteria; and
delivery means for delivering selected electronic documents to the provider.

16. A system comprising:
a preference receiving device that receives one or more preferences for a provider related to types of electronic documents to be delivered to that provider;
a storage device that stores the provider's one or more preferences;
a document selection device that selects electronic documents for delivery based upon the one or more preferences related to the types of documents and one or more content-based criteria; and
a document delivery device that delivers electronic documents along with code for publishing the electronic documents.

17. A method comprising:
receiving a request for at least one electronic document from a provider of electronic documents and at least one content-based criteria;
selecting electronic documents based on the provider's pre-selected preferences and the at least one content-based criteria; and
enabling the provider to publish the preferred types of documents.

18. The method of claim 17, wherein the preferred type of electronic document is an image advertisement.

19. The method of claim 17, wherein the preferred type of electronic document is an audio file.

20. The method of claim 17, wherein the preferred type of electronic document is a flash file.

21. A method comprising:
enabling an electronic advertisement provider to indicate to a centralized electronic advertisement distribution system at least one preference regarding one or more types of electronic advertisements that electronic advertisement provider is to receive for publication through channels controlled by that electronic advertisement provider, the one or more types including a text-based electronic advertisement and an image-based electronic advertisement;
receiving a request for at least one advertisement, the request including one or more content-based criteria about which the advertisement is to be related;
selecting one or more electronic advertisements based on the at least one preference related to the type of electronic advertisement and based on the content-based criteria; and
delivering one or more electronic advertisements to the provider for publication by the provider in electronic documents.
